(19) United States
(12) Patent Application Publication
(10) Pub. No.: US 2015/0214545 A1
(43) Pub. Date: Jul. 30, 2015

(54) NONAQUEOUS ELECTROLYTE SECONDARY BATTERY

(71) Applicant: SANYO Electric Co., Ltd., Daito-shi, Osaka (JP)

(72) Inventors: Kazuhiro Hasegawa, Hyogo (JP); Atsushi Fukui, Hyogo (JP); Takeshi Ogasawara, Hyogo (JP)

(73) Assignee: SANYO Electric Co., Ltd., Daito-shi, Osaka (JP)

(21) Appl. No.: 14/425,149

(22) PCT Filed: Aug. 2, 2013
(86) PCT No.: PCT/JP2013/004695

§ 371 Date: Mar. 2, 2015

(30) Foreign Application Priority Data
Sep. 26, 2012 (JP) 2012-211874

(51) Int. Cl. H01M 4/48; H01M 10/0567; H01M 4/62; H01M 4/587; H01M 4/525; H01M 10/0525; H01M 4/36

(52) U.S. Cl. CPC H01M 4/483; H01M 10/0525; H01M 10/0567; H01M 4/366; H01M 4/587; H01M 4/525; H01M 4/62; H01M 2300/0025; H01M 2220/30

(57) ABSTRACT

To provide a nonaqueous electrolyte secondary battery excellent in high-temperature charge storage characteristics and high-temperature over-discharge storage characteristics. A nonaqueous electrolyte secondary battery of the present invention has a positive electrode including a positive electrode active material which contains a lithium transition metal oxide having a surface to which a rare earth compound is adhered, a negative electrode including a negative electrode active material which contains a graphite and a silicon oxide represented by SiOₓ (0.8≦X≦1.2), and a nonaqueous electrolyte which includes a solvent and a solute and to which a cyclic ether compound is added.

### TECHNICAL FIELD

The present invention relates to a nonaqueous electrolyte secondary battery.

### BACKGROUND ART

In recent years, reduction in size and weight of mobile information terminals, such as a mobile phone, a notebook personal computer, and a smart phone, has been rapidly advanced, and a battery functioning as a drive power source thereof has been required to have a higher capacity. In order to respond to the requirement as described above, a nonaqueous electrolyte secondary battery which performs charge and discharge by the transfer of lithium ions between a positive electrode and a negative electrode has been widely used.

However, nowadays, since the mobile information terminals described above tend to consume a larger amount of electric power in association with enhancement of entertainment functions, such as a video reproduction function and a game function, the nonaqueous electrolyte secondary battery is required to have a higher capacity.

Incidentally, as measures to increase the capacity of the nonaqueous electrolyte secondary battery, for example, there may be mentioned (1) to increase the capacity of an active material, (2) to raise the charge voltage, and (3) to increase the packing density by an increase in packing amount of an active material.

However, when the method (2) is employed (in particular, when the charge voltage is set to be higher than 4.3 V), a nonaqueous electrolyte is liable to be decomposed. Hence, when the nonaqueous electrolyte secondary battery is stored at a high temperature or is continuously charged, gas generation occurs by decomposition of the nonaqueous electrolyte, and as a result, problems, such as swelling of the battery and/or increase in internal pressure thereof, may arise in some cases.

To overcome the problems described above, as disclosed in Patent Document 1, a proposal has been made in which by the use of a positive electrode active material which is formed by adhering dispersed fine particles of a rare earth hydroxide or a rare earth oxyhydroxide to the surface of a lithium transition metal oxide, an electrolyte decomposition reaction during high-temperature charge storage is suppressed, and the battery swelling is suppressed.

In addition, as disclosed in Patent Document 2, a proposal has been made in which by the use of a nonaqueous electrolyte to which 1,3-dioxane is added, high-temperature storage characteristics and cycle characteristics are improved.

### CITATION LIST

### Patent Document

Patent Document 1: Japanese Published Unexamined Patent Application No. 2011-159619

Patent Document 2: WO2007-139130

### SUMMARY OF INVENTION

### Technical Problem

When the technique disclosed in the Patent Document 1 and that disclosed in the Patent Document 2 are used in combination, high-temperature charge storage characteristics are improved. However, the present inventors found that in the case in which those techniques are used in combination, during over-discharge storage (in particular, during high-temperature over-discharge storage), reductive decomposition of a cyclic ether, such as 1,3-dioxane, occurs at the surface of a positive electrode active material to generate a gas, and as a result, the battery swelling occurs.

### Solution to Problem

One aspect of the present invention comprises: a positive electrode including a positive electrode active material which contains a lithium transition metal oxide having a surface to which a rare earth compound is adhered; a negative electrode including a negative electrode active material which contains a graphite and a silicon oxide represented by SiOₓ (0.8≦x≦1.2); and a nonaqueous electrolyte which includes a solvent and a solute and to which a cyclic ether compound is added.

### Advantageous Effects of Invention

According to one aspect of the present invention, an excellent effect of improving the high-temperature charge storage characteristics and the over-discharge storage characteristics (in particular, the high-temperature over-discharge storage characteristics) can be obtained.

### BRIEF DESCRIPTION OF DRAWINGS

FIG. 1 is a graph showing the relationship between the potential and the discharge time during battery discharge.

### DESCRIPTION OF EMBODIMENTS

### (Lithium Transition Metal Oxide)

As a lithium transition metal oxide according to one aspect of the present invention, a layered rock-salt type lithium transition metal oxide represented by the general formula of Li_{y}M¹O₂ (0.9≦y≦1.5 holds, and M¹ includes at least one element selected from Co, Ni, and Mn), a spinel type lithium transition metal oxide represented by the general formula of Li_{z}M²₂O₄ (0.9≦z≦1.1 holds, and M² includes at least Mn), and an olivine type lithium transition metal oxide represented by the general formula of LiₐM³PO₄ (0.9≦a≦1.1 holds, and M³ includes at least one element selected from Fe, Co, and Mn) may be mentioned by way of example.

Among those mentioned above, the layered rock-salt type lithium transition metal oxide, which has a high operation voltage and which may have a high energy density, is preferable, and in particular, lithium cobalt oxide represented by the general formula of Li_{b}Co_{c}M⁴_{1-c}O₂ (0.9≦b≦1.1 and 0.8≦c≦1.0 hold, and M⁴ includes at least one element selected from Zr, Mg, Ti, Al, Ni, and Mn) is preferable.

### (Rare Earth Compound)

According to one aspect of the present invention, fine particles of a rare earth compound are dispersedly adhered to the surface of the lithium transition metal oxide. By the configuration as described above, since the contact area between the lithium transition metal oxide and a nonaqueous electrolyte is decreased, even in the case of high-temperature charge storage, the nonaqueous electrolyte is not likely to be decomposed. Accordingly, since gas generation in a battery can be suppressed, swelling of the battery and an increase in internal pressure thereof can be suppressed.

In this embodiment, the average particle diameter of the rare earth compound is preferably 100 nm or less and particularly preferably 1 to 100 nm, and in the range described above, an average particle diameter of 10 to 100 nm is preferable. When the average particle diameter of the rare earth compound is less than 1 nm, since the surface of the lithium transition metal oxide is excessively densely covered with the rare earth compound, insertion and desorption of lithium may become difficult in some cases. On the other hand, when the average particle diameter of the rare earth compound is more than 100 nm, the surface of the lithium transition metal oxide is not sufficiently covered with the rare earth compound, and the advantageous effect described above may not be sufficiently obtained in some cases.

The positive electrode active material described above having the structure in which fine particles of the rare earth compound are dispersedly adhered to the surface of the lithium transition metal oxide can be obtained, for example, by a method comprising the steps of: precipitating a hydroxide of a rare earth element in a solution in which the lithium transition metal oxide is dispersed and adhering this hydroxide to the surface of the lithium transition metal oxide. After the hydroxide of the rare earth element is adhered, drying and a heat treatment are generally performed.

As the temperature of the heat treatment in this case, a temperature of 80° C. to 600° C. is generally preferable, and a temperature of 80° C. to 400° C. is particularly preferable. When the temperature of the heat treatment is more than 600° C., some fine particles of the rare earth compound adhered to the surface are diffused inside the lithium transition metal oxide, and an initial charge and discharge efficiency is degraded. Hence, in order to obtain a positive electrode active material which has a high capacity and which has a surface to which the rare earth compound is more selectively adhered, the heat treatment temperature is preferably controlled to be 600° C. or less. On the other hand, when the heat treatment temperature is less than 80° C., since moisture may remain on the surface of the lithium transition metal oxide in some cases, the heat treatment is preferably performed at 80° C. or more. In addition, a hydroxide precipitated on the surface is transformed, for example, into a hydroxide, an oxyhydroxide, or an oxide by a subsequent heat treatment. Hence, the rare earth compound adhered to the surface of the positive electrode active material according to one aspect of the present invention is adhered in the form of a hydroxide, an oxyhydroxide, an oxide, or the like.

In this embodiment, when the heat treatment is performed at 400° C. or less, the hydroxide and/or the oxyhydroxide is mostly formed, and when the heat treatment is performed at a temperature of more than 400° C., the oxide is mostly formed. In addition, the heat treatment time is generally preferably 3 to 7 hours.

In the positive electrode active material according to one aspect of the present invention, the rate of the rare earth compound with respect to the lithium transition metal oxide is preferably 0.005 to 1.0 percent by mass on the rare earth element basis and particularly preferably 0.01 to 0.3 percent by mass. When the adhesion amount of the rare earth compound is less than 0.005 percent by mass, improvement in high-temperature charge storage characteristics may not be sufficiently obtained in some cases. On the other hand, when the adhesion amount of the rare earth compound is more than 1.0 percent by mass, the polarization is enhanced, and as a result, battery characteristics may be degraded in some cases.

Although the rare earth element of the rare earth compound is not particularly limited, for example, erbium, samarium, neodymium, ytterbium, terbium, dysprosium, holmium, thulium, lutetium, and lantern may be mentioned. Among those mentioned above, samarium, neodymium, and erbium, each of which has a significant effect of improving the charge storage characteristics, are preferable.

### (Nonaqueous Electrolyte)

A nonaqueous electrolyte used in one aspect of the present invention contains a cyclic ether compound. According to the configuration as described above, the cyclic ether compound is preferentially decomposed at a positive electrode side during initial charge, and a coating film is formed on the surface of the positive electrode active material. In addition, since this coating film functions as a protective coating film which suppresses the decomposition of the nonaqueous electrolyte, even in the case of high-temperature charge storage, the nonaqueous electrolyte is not likely to be decomposed. Hence, since gas generation is suppressed in a battery, swelling of the battery and an increase in internal pressure thereof can be suppressed.

In this embodiment, the rate of the cyclic ether compound with respect to a solvent of the nonaqueous electrolyte is preferably 0.1 to 10 percent by mass and particularly preferably 0.5 to 2 percent by mass. When the rate of the cyclic ether compound is less than 0.1 percent by mass, the amount of the cyclic ether compound which is oxidatively decomposed at the surface of the positive electrode active material is decreased, and the protective function of the positive electrode active material may not be sufficiently obtained. Hence, the battery swelling during high-temperature charge storage may not be sufficiently suppressed in some cases. On the other hand, when the amount of the cyclic ether compound is more than 10 percent by mass, even when SiOₓ is added to a negative electrode, since the amount of reductive decomposition is increased at the surface of the positive electrode active material during high-temperature over-discharge storage, the battery swelling during high-temperature over-discharge storage may not be sufficiently suppressed in some cases.

As examples of the above cyclic ether compound, for example, 1,3-dioxane, 1,4-dioxane, 4-methyl-1,3-dioxolane, tetrahydrofuran, 2-methyltetrahydrofuran, propylene oxide, 1,2-butylene oxide, 1,3,5-trioxane, furan, 2-methylfuran, 1,8-cineole, and a crown ether may be mentioned. Among those mentioned above, in particular, 1,3-dioxane and 1,4-dioxane are preferable.

In addition, besides the above cyclic ether compound, in the nonaqueous electrolyte, a compound having a sulfonyl group is preferably contained. The rate of the compound having a sulfonyl group with respect to the solvent of the nonaqueous electrolyte is preferably 0.1 to 10 percent by mass and particularly preferably 0.5 to 2 percent by mass. When the rate of the compound having a sulfonyl group is less than 0.1 percent by mass, the amount thereof forming a coating film is decreased at the surface of the positive electrode active material, and the effect of improving the high-temperature charge storage characteristics is degraded. On the other hand, when the rate of the compound having a sulfonyl group is more than 10 percent by mass, since the amount of the coating film at the surface of the positive electrode active material is increased, the discharge performance is degraded.

As the compound having a sulfonyl group, for example, there may be mentioned 1,3-propanesultone, 1,3-propenesultone, 1,4-butanesultone, dimethyl sulfone, ethyl methyl sulfone, diethyl sulfone, ethyl vinyl sulfone, ethylene glycol dimethanesulfonate, 1,3-propanediol dimethanesulfonate, 1,5-pentanediol dimethanesulfonate, and 1,4-butanediol diethanesulfonate. Among those mentioned above, in particular, 1,3-propanesultone, 1,3-propenesultone, and 1,4-butanesultone are preferable.

The solvent and the solute of the nonaqueous electrolyte are not particularly limited as long as being usable for a nonaqueous electrolyte secondary battery.

As the solute of the above nonaqueous electrolyte, LiBF₄, LiPF₆, LiN(SO₂CF₃)₂, LiN(SO₂C₂F₅)₂, LiPF₆₋ₓ(CₙF₂ₙ₊₁)ₓ [where 1<x<6 holds, and n represents 1 or 2], or a lithium salt in which an oxalato complex functions as an anion may be used. As the lithium salt in which an oxalato complex functions as an anion, besides LiBOB [lithium bis(oxalato)borate], a lithium salt having an anion in which C₂O₄²⁻ is coordinated to a central atom, such as Li[M(C₂O₄)ₓR_{y}] (in the formula, M represents an element selected from transition metals and elements of Groups IIIb, IVb, and Vb of the periodic table, R represents a group selected from a halogen, an alkyl group, and a halogenated alkyl group, x represents a positive integer, and y represents 0 or a positive integer), may be used. In particular, for example, Li[B(C₂O₄)F₂], Li[P(C₂O₄)F₄], and Li[P(C₂O₄)₂F₂] may also be mentioned.

However, in order to form a stable coating film on the surface of the negative electrode even in a high-temperature environment, LiBOB is most preferably used.

In addition, the solutes described above may be used alone, and at least two types thereof may also be used in combination. Although the concentration of the solute is not particularly limited, 0.8 to 1.7 moles per one liter of the electrolyte is preferable. Furthermore, in the application in which large current discharge is required, the concentration of the solute is preferably 1.0 to 1.6 moles per one liter of the electrolyte.

In addition, as the solvent of the nonaqueous electrolyte, for example, a carbonate solvent, such as ethylene carbonate, propylene carbonate, y-butyrolactone, diethylene carbonate, ethyl methyl carbonate, or dimethyl carbonate, may be preferably used, or a carbonate solvent in which at least one hydrogen atom of each of the solvents mentioned above is substituted by F may also be preferably used. As the solvent, a cyclic carbonate and a chain carbonate are preferably used in combination.

### (Negative Electrode Active Material)

As a negative electrode active material according to one aspect of the present invention, a mixture containing a graphite and SiOₓ (0.8≦x≦1.2) is used. According to the configuration as described above, during not only high-temperature charge storage but also over-discharge storage (in particular, high-temperature over-discharge storage), battery swelling caused by gas generation can be suppressed. It is believed that this suppression is obtained by the following reasons.

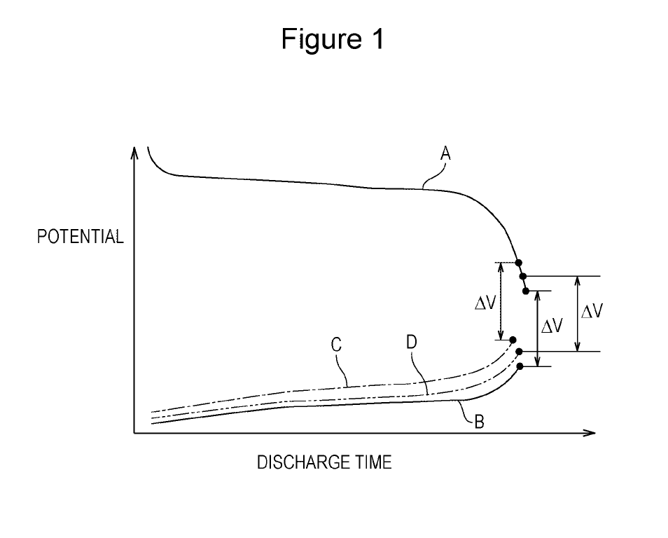

As described above, when the positive electrode active material having a surface to which a rare earth compound is adhered and the nonaqueous electrolyte to which a cyclic ether compound is added are used, the high-temperature charge storage characteristics can be improved. However, the cyclic ether compound is reductively decomposed at the surface of the positive electrode active material during over-discharge storage, gas is generated, and hence battery swelling occurs. This phenomenon will be described with reference to FIG. 1. In FIG. 1, a line segment A represents a discharge curve of the positive electrode, and a line segment B represents a discharge curve of the negative electrode obtained when the negative electrode active material is formed only from a graphite (the case in which SiOₓ is not contained in the negative electrode active material). In addition, a line segment C represents a discharge curve of the negative electrode obtained when the negative electrode active material is formed from a graphite and SiO, and a line segment D represents a discharge curve of the negative electrode obtained in the case in which although the negative electrode active material is formed from a graphite and SiOₓ, the rate of SiOₓ is small.

Although at the stage at which the potential difference ΔV between the positive and the negative electrodes is decreased (such as 2 V), the discharge is finished, when the negative electrode active material is formed only from a graphite, at the stage at which the potential difference (potential difference between the line segment A and the line segment B) ΔV reaches 2 V, the positive electrode potential is remarkably decreased. Hence, the cyclic ether compound is reductively decomposed at the surface of the positive electrode active material. On the other hand, when the negative electrode active material is formed from a graphite and SiOₓ, at the stage at which the potential difference (potential difference between the line segment A and the line segment C) ΔV reaches 2 V, the decrease in positive electrode potential can be suppressed. Hence, the cyclic ether compound can be suppressed from being reductively decomposed at the surface of the positive electrode active material. By the reasons described above, when the negative electrode active material is formed from a graphite and SiOₓ, since the reductive decomposition of the cyclic ether compound can be suppressed, the over-discharge storage characteristics are improved.

However, in the case in which although the negative electrode active material is formed from a graphite and SiOₓ, the rate of SiOₓ is small, at the stage at which the potential difference (potential difference between the segment A and the segment D) ΔV reaches 2 V, the decrease in positive electrode potential cannot be sufficiently suppressed. Hence, the cyclic ether compound may not be sufficiently suppressed from being reductively decomposed at the surface of the positive electrode active material in some cases. Accordingly, the rate of SiOₓ with respect to the total amount of the negative electrode active material is preferably 0.5 percent by mass or more.

On the other hand, the upper limit of the rate of SiOₓ with respect to the total amount of the negative electrode active material is preferably 10 percent by mass or less and particularly preferably 5 percent by mass or less. When the rate of SiOₓ is more than 10 percent by mass, the amount of expansion and shrinkage of the negative electrode active material during charge and discharge is increased, and the charge/discharge cycle characteristics may be degraded in some cases.

In this embodiment, the graphite described above is not particularly limited as long as being usable for a nonaqueous electrolyte secondary battery. For example, an artificial graphite, a natural graphite, or a graphite having a surface coated with amorphous carbon may be mentioned.

In addition, the reason the value X of SiOₓ is limited to satisfy 0.8≦X≦1.2 is that when the value X is less than 0.8, since the Si rate in SiOₓ is increased, the amount of expansion and shrinkage of the negative electrode active material is increased during charge and discharge, and charge/discharge cycle characteristics are degraded. On the other hand, when X is more than 1.2, the irreversible capacity at the first charge and discharge is increased, and the initial charge/discharge efficiency is decreased, so that the battery capacity is decreased.

In addition, the surface of SiOₓ may be covered with a carbon coating film. However, even if the surface of SiOₓ is not covered with a carbon coating film, the effect of one aspect of the present invention can be obtained.

### EXAMPLES

Hereinafter, although the present invention will be described in more detail with reference to examples, the present invention is not limited at all to the following examples and may be appropriately changed and modified without departing from the scope of the present invention.

### Example 1

### [Formation of Positive Electrode]

### (1) Formation of Lithium Transition Metal Oxide

Lithium cobalt oxide in which 1.5 percent by mole of Mg and 1.5 percent by mole of Al were solid-solved and in which 0.05 percent by mole of Zr was contained was formed. In particular, Li₂CO₃, Co₃O₄, MgO, Al₂O₃, and ZrO₂ used as raw materials were mixed together at a predetermined ratio and were then heat-treated at 850° C. for 24 hours in an air atmosphere, so that the lithium cobalt oxide was formed.

### (2) Formation of Positive Electrode Active Material

To 3 liters of purified water, 1,000 g of the above lithium cobalt oxide was added and stirred, so that a suspension in which the lithium cobalt oxide was dispersed was prepared. Next, to this suspension, a solution in which 3.18 g of erbium nitrate pentahydrate was dissolved was added. When the solution in which erbium nitrate pentahydrate was dissolved was added to the suspension, an aqueous solution of sodium hydroxide at a concentration of 10 percent by mass was added so that the pH of the solution in which the lithium cobalt oxide was contained was maintained at 9. Subsequently, after the liquid thus prepared was processed by suction filtration and then washed with water, a powder obtained thereby was dried at 120° C. Accordingly, lithium cobalt oxide having a surface to which erbium hydroxide was uniformly adhered was obtained.

Subsequently, the lithium cobalt oxide to which erbium hydroxide was adhered was heat-treated at 300° C. for 5 hours in the air, so that a positive electrode active material was obtained. When the positive electrode active material thus obtained was observed using a scanning electron microscope (SEM), an erbium compound having an average grain diameter of 100 nm or less was uniformly adhered to the surface of the lithium cobalt oxide in a uniformly dispersed state. The adhesion amount of the erbium compound was 0.12 percent by mass with respect to the lithium cobalt oxide on the erbium element basis. Incidentally, the adhesion amount of the erbium compound was measured by ICP (Inductively Coupled Plasma Emission Analysis).

### (3) Formation of Positive Electrode

The positive electrode active material described above, acetylene black functioning as a conductive agent, and an N-methyl-2-pyrollidone solution in which a poly(vinylidene fluoride) functioning as a binder was dissolved were mixed together to prepare a positive electrode mixture slurry. In this case, the ratio of the positive electrode active material, the conductive agent, and the binder was set on a weight basis to 95:2.5:2.5. Finally, after this positive electrode mixture slurry was applied to both sides of aluminum foil functioning as a positive electrode collector and was then dried, rolling was further performed so as to form a positive electrode active material having a packing density of 3.60 g/cm³, thereby forming a positive electrode.

### [Formation of Negative Electrode]

### (1) Formation of Silicon Oxide Functioning as Negative Electrode Active Material

First, carbon was coated on the surfaces of SiOₓ (X=0.93) grains so that the rate of carbon with respect to SiOₓ was set to 10 percent by mass. In addition, the coating of carbon was performed in an argon atmosphere using a CVD method. Next, after the SiOₓ grains covered with carbon were processed by a disproportionation treatment at 1,000° C. in an argon gas atmosphere, crushing and classification were performed, so that SiOₓ functioning as a negative electrode active material was obtained.

### (2) Formation of Negative Electrode

A graphite (artificial graphite) and the above SiOₓ were mixed together to form a negative electrode active material. In this step, the rate of SiOₓ with respect to the total amount (total of the graphite and SiOₓ) of the negative electrode active material was controlled to be 2 percent by mass. Next, this negative electrode active material, CMC functioning as a dispersant, and SBR functioning as a binder were stirred in an aqueous solution so that the mass ratio of the negative electrode active material, the dispersant, and the binder was 97:1.5:1.5, thereby preparing a negative electrode mixture slurry. Subsequently, by using a doctor blade method, after the negative electrode mixture slurry was applied to both sides of a negative electrode collector formed of copper foil and was then dried, rolling was further performed so as to form a negative electrode active material having a packing density of 1.70 g/cm³, thereby forming a negative electrode.

### [Preparation of Nonaqueous Electrolyte]

Ethylene carbonate (EC), ethyl methyl carbonate (EMC), and diethyl carbonate (DEC) were mixed together so that the volume ratio was 3:6:1, thereby preparing a mixed solvent. Next, to this mixed solvent, 0.5 percent by mass of 1,3-dioxane (cyclic ether compound) was added, and furthermore, lithium hexafluorophosphate (LiPF₆) was dissolved at a rate of 1 mole/L, thereby preparing a nonaqueous electrolyte.

### [Formation of Battery]

The positive electrode and the negative electrode were wound to face each other with at least one separator provided therebetween, so that a wound body was formed. Subsequently, the wound body thus formed was sealed in an aluminum laminate together with the nonaqueous electrolyte in a glove box in an argon atmosphere, so that a nonaqueous electrolyte secondary battery having a battery capacity of 800 mAh was obtained. In addition, as for the battery size, the thickness, the width, and the length were 3.6 mm, 3.5 cm, and 6.2 cm, respectively.

Hereinafter, the battery thus formed was called a battery A1.

### Examples 2 and 3

Except that when the nonaqueous electrolyte was prepared, the rates of 1,3-dioxane with respect to the mixed solvent were set to 1.0 and 2.0 percent by mass, batteries were formed in a manner similar to that of Example 1.

Hereinafter, the batteries thus formed were called batteries A2 and A3, respectively.

### Example 4

Except that as the cyclic ether compound to be added when the nonaqueous electrolyte was prepared, 1,4-dioxane was used instead of using 1,3-dioxane, a battery was formed in a manner similar to that of Example 2.

Hereinafter, the battery thus formed was called battery A4.

### Examples 5 and 6

Except that when the negative electrode active materials were mixed together, the rates of SiOₓ with respect to the total amount of the negative electrode active materials were set to 0.5 and 5.0 percent by mass, batteries were formed in a manner similar to that of Example 2.

Hereinafter, the batteries thus formed were called batteries A5 and A6, respectively.

### Examples 7 to 9

Except that when the nonaqueous electrolyte was prepared, besides 1,3-dioxane, 1,3-propanesultone, 1,3-propenesultone, and 1,4-butanesultone were separately added, batteries were formed in a manner similar to that of Example 2. In this case, the rates of 1,3-propanesultone, 1,3-propenesultone, and 1,4-butanesultone with respect to the mixed solvent were each 1.0 percent by mass.

Hereinafter, the batteries thus formed were called batteries A7 to A9, respectively.

### Example 10

Except that as the rare earth compound adhered to the surface of the lithium cobalt oxide, a neodymium compound was used instead of using the erbium compound, a battery was formed in a manner similar to that of Example 2. In particular, when the positive electrode active material was formed, instead of using an aqueous solution in which 3.18 g of erbium nitrate pentahydrate was dissolved, an aqueous solution in which 3.65 g of neodymium nitrate hexahydrate was dissolved was used, and this was a different point.

When the positive electrode active material thus obtained was observed by a SEM, a neodymium compound having an average grain diameter of 100 nm or less was uniformly adhered to the surface of the positive electrode active material in a uniformly dispersed state.

The adhesion amount of the neodymium compound was 0.12 percent by mass with respect to the lithium cobalt oxide on the neodymium element basis. In addition, the adhesion amount of the neodymium compound was measured by ICP.

Hereinafter, the battery thus formed was called battery A10.

### Example 11

Except that as the rare earth compound adhered to the surface of the lithium cobalt oxide, a samarium compound was used instead of using the erbium compound, a battery was formed in a manner similar to that of Example 2. In particular, when the positive electrode active material was formed, instead of using an aqueous solution in which 3.18 g of erbium nitrate pentahydrate was dissolved, an aqueous solution in which 3.54 g of samarium nitrate hexahydrate was dissolved was used, and this was a different point.

When the positive electrode active material thus obtained was observed by a SEM, a samarium compound having an average grain diameter of 100 nm or less was uniformly adhered to the surface of the positive electrode active material in a uniformly dispersed state. The adhesion amount of the samarium compound was 0.12 percent by mass with respect to the lithium cobalt oxide on the samarium element basis. In addition, the adhesion amount of the samarium compound was measured by ICP.

Hereinafter, the battery thus formed was called battery A11.

### Example 12

Except that as the rare earth compound adhered to the surface of the lithium cobalt oxide, a lantern compound was used instead of using the erbium compound, a battery was formed in a manner similar to that of Example 2. In particular, when the positive electrode active material was formed, instead of using an aqueous solution in which 3.18 g of erbium nitrate pentahydrate was dissolved, an aqueous solution in which 3.75 g of lantern nitrate hexahydrate was dissolved was used, and this was a different point.

When the positive electrode active material thus obtained was observed by a SEM, a lantern compound having an average grain diameter of 100 nm or less was uniformly adhered to the surface of the positive electrode active material in a uniformly dispersed state.

The adhesion amount of the lantern compound was 0.12 percent by mass with respect to the lithium cobalt oxide on the lantern element basis. In addition, the adhesion amount of the lantern compound was measured by ICP.

Hereinafter, the battery thus formed was called battery A12.

### Comparative Example 1

Except that as the negative electrode active material, the graphite was only used (SiOₓ was not contained), a battery was formed in a manner similar to that of Example 2.

Hereinafter, the battery thus formed was called battery Z1.

### Comparative Example 2

Except that when the nonaqueous electrolyte was prepared, diethyl ether was added instead of 1,3-dioxane, a battery was formed in a manner similar to that of Example 2.

Hereinafter, the battery thus formed was called battery Z2.

### Comparative Example 3

Except that the graphite was only used as the negative electrode active material, and when the nonaqueous electrolyte was prepared, 1,3-dioxane was not added, a battery was formed in a manner similar to that of Example 2.

Hereinafter, the battery thus formed was called battery Z3.

### Comparative Example 4

Except that as the rare earth compound adhered to the surface of the lithium cobalt oxide, a zirconium compound was used instead of using the erbium compound, a battery was formed in a manner similar to that of Example 2. In particular, when the positive electrode active material was formed, instead of using an aqueous solution in which 3.18 g of erbium nitrate pentahydrate was dissolved, an aqueous solution in which 3.51 g of zirconium oxynitrate dihydrate was dissolved was used, and this was a different point.

When the positive electrode active material thus obtained was observed by a SEM, a zirconium compound having an average grain diameter of 100 nm or less was uniformly adhered to the surface of the positive electrode active material in a uniformly dispersed state. The adhesion amount of the zirconium compound was 0.12 percent by mass with respect to the lithium cobalt oxide on the zirconium element basis. In addition, the adhesion amount of the zirconium compound was measured by ICP.

Hereinafter, the battery thus formed was called battery Z4.

### Comparative Example 5

Except that as the negative electrode active material, the graphite was only used (SiOₓ was not contained), a battery was formed in a manner similar to that of Comparative Example 4.

Hereinafter, the battery thus formed was called battery Z5.

### (Experiments)

The batteries A1 to A12 and Z1 to Z5 were each charged and discharged under the following conditions, and the high-temperature charge storage characteristics (high-temperature charge storage swelling) and the high-temperature over-discharge storage characteristics (high-temperature over-discharge storage swelling) of each battery were investigated. The results thus obtained are shown in Table 1.

### [High-Temperature Charge Storage Characteristics]

After constant current charge was performed at a current of 1.0 It (800 mA) until the battery voltage reached 4.4 V, constant voltage charge was performed at a constant voltage of 4.4 v until the current reached 0.05 It (40 mA). After this charge was completed, a battery thickness Ta before storage was measured. Next, the battery thus charged was stored in a constant-temperature bath at 80° C. for 2 days and was then recovered therefrom. Subsequently, after the battery was left at room temperature for 1 hour, a battery thickness Tb after storage was measured, and the high-temperature charge storage swelling was calculated from the following equation (1).

High-Temperature Charge Storage Swelling=(Battery Thickness Tb after Storage)−(Battery Thickness Ta before Storage) (1)

### [High-Temperature Over-Discharge Storage Characteristics]

After constant current discharge was performed at a current of 0.2 It (160 mA) until the battery voltage reached 2.0 v, a battery thickness Tc before storage was measured. Next, the battery thus discharged was stored in a constant-temperature bath at 60° C. for 20 days and was then recovered therefrom. Subsequently, after the battery was left at room temperature for 1 hour, a battery thickness Td after storage was measured, and the high-temperature over-discharge storage swelling was calculated from the following equation (2).

High-Temperature Over-Discharge Storage Swelling=(Battery Thickness Td after Storage)−(Battery Thickness Tc before Storage) (1)

TABLE 1

| | | | | Additive to Nonaqueous Electrolyte | | | | | High- |
|---|---|---|---|---|---|---|---|---|---|
| | | Negative | | Cyclic Ether | | Compound Having | | High- | Temperature |
| | Substance | Electrode | | Compound | | Sulfonyl Group | | Temperature | Over- |
| | Adhered to | Negative | Rate of | | Addition | | Addition | Charge | Discharge |
| | Surface of | Electrode | Sioₓ | | Amount | | Amount | Storage | Storage |
| | Lithium | Active | (percent | | (percent | | (percent | Swelling | Swelling |
| Battery | Cobalate | Material | by mass) | Type | by mass) | Type | by mass) | (mm) | (mm) |
| A1 | Er Compound | Graphite + | 2.0 | 1,3-Dioxane | 0.5 | None | — | 0.39 | 0.05 |
| A2 | | SiOₓ | | | 1.0 | | | 0.42 | 0.05 |
| A3 | | | | | 2.0 | | | 0.40 | 0.07 |
| A4 | | | | 1,4-Dioxane | 1.0 | | | 0.50 | 0.04 |
| A5 | | | 0.5 | 1,3-Dioxane | | | | 0.42 | 0.12 |
| A6 | | | 5.0 | | | | | 0.38 | 0.01 |
| A7 | | | 2.0 | | | 1,3-Propane | 1.0 | 0.30 | 0.02 |
| | | | | | | Sultone | | | |
| | | | | | | 1,3-Propene | | 0.15 | 0.04 |
| A8 | | | | | | Sultone | | | |
| A9 | | | | | | 1,4-Butane | | 0.32 | 0.03 |
| | | | | | | Sultone | | | |
| A10 | Nd Compound | | | | | None | — | 0.44 | 0.04 |
| A11 | Sm Compound | | | | | | | 0.46 | 0.03 |
| A12 | La Compound | | | | | | | 0.72 | 0.03 |
| Z1 | Er Compound | Graphite | — | | | | | 0.44 | 0.30 |
| Z2 | | Graphite + | 2.0 | None | | | | 1.22 | 0.03 |
| | | SiOₓ | | (however, | | | | | |
| | | | | diethyl | | | | | |
| | | | | ether was | | | | | |
| | | | | added.) | | | | | |
| Z3 | | Graphite | — | None | — | | | 1.82 | 0.03 |
| Z4 | Zr Compound | Graphite + | 2.0 | 1,3-Dioxane | 1.0 | | | 0.94 | 0.04 |
| | | SiOₓ | | | | | | | |
| Z5 | | Graphite | — | | | | | 0.90 | 0.20 |

As apparent from the above Table 1, it is found that the batteries A1 to A12 are superior in high-temperature charge storage characteristics since having small high-temperature charge storage swelling and are also superior in high-temperature over-discharge storage characteristics since having small high-temperature over-discharge storage swelling. The reasons for this are that the rare earth compound is adhered to the surface of the lithium cobalt oxide, the cyclic ether compound is added to the nonaqueous electrolyte, and SiOₓ is contained in the negative electrode active material.

On the other hand, in the battery Z1, it is found that although the high-temperature charge storage characteristics are superior, the high-temperature over-discharge storage characteristics are inferior. In the battery Z1, since the rare earth compound is adhered to the surface of the lithium cobalt oxide, and the cyclic ether compound is added to the nonaqueous electrolyte, the high-temperature charge storage characteristics are superior. However, since SiOₓ is not contained in the negative electrode active material, the high-temperature over-discharge storage characteristics are inferior.

In addition, in the battery Z2, it is found that although the high-temperature charge storage characteristics are inferior, the high-temperature over-discharge storage characteristics are superior. In the battery Z2, although the rare earth compound is adhered to the surface of the lithium cobalt oxide, since the cyclic ether compound is not added to the nonaqueous electrolyte, the high-temperature charge storage characteristics are inferior. However, since the cyclic ether compound is not added as described above, the high-temperature over-discharge storage characteristics are superior.

Furthermore, in the battery Z3, it is found that although the high-temperature charge storage characteristics are inferior, the high-temperature over-discharge storage characteristics are superior. In the battery Z3, although the rare earth compound is adhered to the surface of the lithium cobalt oxide, since the cyclic ether compound is not added to the nonaqueous electrolyte, the high-temperature charge storage characteristics are inferior.

However, since the cyclic ether compound is not added, the high-temperature over-discharge storage characteristics are superior. In addition, in the battery Z4, it is found that although the high-temperature charge storage characteristics are inferior, the high-temperature over-discharge storage characteristics are superior. In the battery Z4, although the cyclic ether compound is added to the nonaqueous electrolyte, since the rare earth compound is not adhered to the surface of the lithium cobalt oxide (Zr compound is only adhered thereto), the high-temperature charge storage characteristics are inferior. However, since SiO_{X} is contained in the negative electrode active material, the high-temperature over-discharge storage characteristics are superior.

In addition, in the battery Z5, it is found that the high-temperature charge storage characteristics are inferior, and the high-temperature over-discharge storage characteristics are also inferior. In the battery Z5, although the cyclic ether compound is added to the nonaqueous electrolyte, since the rare earth compound is not adhered to the surface of the lithium cobalt oxide, the high-temperature charge storage characteristics are inferior. In addition, since SiOₓis not contained in the negative electrode active material, the high-temperature over-discharge storage characteristics are inferior.

In addition, it is found that when the batteries A1 to A3 in which the addition amount of 1,3-dioxane is only different from each other are compared, the above batteries have approximately the same characteristics. Hence, when the addition amount of 1,3-dioxane is 0.5 to 2 percent by mass, the advantageous effect of one aspect of the present invention can be sufficiently obtained. In addition, it is found that when the batteries A2 and A4 in which the type of cyclic ether compound is only different from each other are compared, the above batteries have approximately the same characteristics. Hence, as long as a cyclic ether compound is used, the advantageous effect of one aspect of the present invention can be sufficiently obtained. Furthermore, it is found that when the batteries A2, A5, and A6 in which the rate of SiOₓ is only different from each other are compared, the high-temperature over-discharge storage characteristics are improved as the rate of SiOₓ is increased. Hence, in order to improve the high-temperature over-discharge storage characteristics, the rate of SiOₓis preferably increased.

In addition, it is found that when the battery A2 is compared to the batteries A7 to A9, the only point of which different from the battery A 2 is that the compound having a sulfonyl group is added, the batteries A7 to A9 in each of which the compound having a sulfonyl group is added are superior to the battery A2 in which the above compound is not added in terms of the high-temperature charge storage characteristics and the high-temperature over-discharge storage characteristics. Hence, it is preferable that the compound having a sulfonyl group be added to the nonaqueous electrolyte.

From the battery A2 and the batteries A10 to A12, it is found that regardless of the type of rare earth compound which is adhered to the surface of the lithium cobalt oxide, the advantageous effect of one aspect of the present invention can be sufficiently obtained. In particular, it is found that when the rare earth compound is a compound of samarium, neodymium, or erbium, the high-temperature charge storage swelling can be further suppressed.

1. A nonaqueous electrolyte secondary battery comprising:
a positive electrode including a positive electrode active material which contains a lithium transition metal oxide having a surface to which a rare earth compound is adhered;
a negative electrode including a negative electrode active material which contains a graphite and a silicon oxide represented by SiOₓ (0.8≦X≦1.2); and
a nonaqueous electrolyte which includes a solvent and a solute and to which a cyclic ether compound is added.

2. The nonaqueous electrolyte secondary battery according to claim 1,
wherein the lithium transition metal oxide includes at least one selected from the group consisting of a layered rock-salt type lithium transition metal oxide represented by the general formula of Li_{y}M¹O₂ (0.9≦y≦1.5 holds, and M¹ includes at least one element selected from Co, Ni, and Mn), a spinel type lithium transition metal oxide represented by the general formula of Li_{z}M²₂O₄ (0.9≦z≦1.1 holds, and M² includes at least Mn), and an olivine type lithium transition metal oxide represented by the general formula of LiₐM³PO₄ (0.9≦a≦1.1 holds, and M³ includes at least one element selected from Fe, Co, and Mn).

3. The nonaqueous electrolyte secondary battery according to claim 2,
wherein the lithium transition metal oxide includes a lithium cobalt oxide represented by the general formula of Li_{b}Co_{c}M⁴_{1-c}O₂ (0.9≦b≦1.1 and 0.8≦c≦1.0 hold, and M⁴ includes at least one element selected from Zr, Mg, Ti, Al, Ni, and Mn).

4. The nonaqueous electrolyte secondary battery according to claim 1,
wherein the rare earth compound includes a rare earth oxyhydroxide, a rare earth hydroxide, or a rare earth oxide.

5. The nonaqueous electrolyte secondary battery according to claim 1,
wherein the rare earth element of the rare earth compound includes samarium, neodymium, or erbium.

6. The nonaqueous electrolyte secondary battery according to claim 1,
wherein the rate of the cyclic ether compound with respect to the solvent of the nonaqueous electrolyte is 0.1 to 10 percent by mass.

7. The nonaqueous electrolyte secondary battery according to claim 1,
wherein the cyclic ether compound includes 1,3-dioxane and/or 1,4-dioxane.

8. The nonaqueous electrolyte secondary battery according to claim 1,
wherein the rate of the silicon oxide to the total amount of the negative electrode active material is 0.5 to 10 percent by mass.

9. The nonaqueous electrolyte secondary battery according to claim 1,
wherein the surface of the silicon oxide is coated with carbon.

10. The nonaqueous electrolyte secondary battery according to claim 1,
wherein to the nonaqueous electrolyte, a compound having a sulfonyl group is further added, and the rate of the compound having a sulfonyl group with respect to the solvent of the nonaqueous electrolyte is 0.1 to 10 percent by mass.

11. The nonaqueous electrolyte secondary battery according to claim 10,
wherein the compound having a sulfonyl group includes at least one type selected from the group consisting of 1,3-propanesultone, 1,3-propenesultone, and 1,4-butanesultone.
